(19) United States
(12) Patent Application Publication
(10) Pub. No.: US 2022/0140495 A1
(43) Pub. Date: May 5, 2022

(54) ANTENNA ELEMENT, ANTENNA ARRAY AND DISPLAY DEVICE INCLUDING THE SAME

(71) Applicant: DONGWOO FINE-CHEM CO., LTD., Jeollabuk-do (KR)

(72) Inventors: Young Ju KIM, Gyeonggi-do (KR); Yun Seok OH, Gyeonggi-do (KR); Won Hee LEE, Incheon (KR); Byung Jin CHOI, Incheon (KR)

(21) Appl. No.: 17/516,884

(22) Filed: Nov. 2, 2021

(30) Foreign Application Priority Data
Nov. 2, 2020 (KR) 10-2020-0144125

(51) Int. Cl. H01Q 21/08; H01Q 9/04

(52) U.S. Cl. CPC H01Q 21/08; H01Q 9/0407

(57) ABSTRACT

An antenna element according to an embodiment includes: a first radiation body disposed in a first direction; a second radiation body disposed in a second direction; a signal pad configured to supply a signal to the first radiation body and the second radiation body; a first transmission line which extends from the signal pad in the first direction to be connected to the first radiation body; and a second transmission line which extends from the signal pad in the second direction to be connected to the second radiation body.

### CROSS-REFERENCE TO RELATED APPLICATION(S)

This application claims priority to Korean Patent Application No. 10-2020-0144125 filed on Nov. 2, 2020 in the Korean Intellectual Property Office (KIPO), the entire disclosure of which is incorporated by reference herein.

### BACKGROUND

### 1. Field

The present invention relates to an antenna element, and an antenna array and display device including the same.

### 2. Description of the Related Art

Recently, according to development of the information-oriented society, wireless communication techniques such as Wi-Fi, Bluetooth, and the like are implemented, for example, in a form of smartphones by combining with display devices. In this case, an antenna may be coupled to the display device to perform a communication function.

Recently, with mobile communication techniques becoming more advanced, it is necessary for an antenna for performing communication in high frequency or ultra-high frequency bands to be coupled to the display device. In addition, according to development of thin, high-transparency and high-resolution display devices such as a transparent display and a flexible display, it is necessary to develop an antenna so as to also have improved transparency and flexibility.

As the size of a screen of the display device on which the antenna is mounted is increased, a space or area of a bezel part or light-shielding part has been decreased. In this case, the space or area in which the antenna can be embedded may also be limited.

Therefore, it is necessary to design an antenna capable of radiating a signal with a high antenna gain in a limited space without being viewed by the user.

### SUMMARY

It is an object of the present invention to provide an antenna element, and an antenna array and display device including the same.

To achieve the above object, the following technical solutions are adopted in the present invention.

1. An antenna element including: a first radiation body disposed in a first direction; a second radiation body disposed in a second direction; a signal pad configured to supply a signal to the first radiation body and the second radiation body; a first transmission line which extends from the signal pad in the first direction to be connected to the first radiation body; and a second transmission line which extends from the signal pad in the second direction to be connected to the second radiation body.

2. The antenna element according to the above 1, wherein the first transmission line and the second transmission line having one end connected to the signal pad, respectively.

3. The antenna element according to the above 2, wherein the first transmission line, the second transmission line and the signal pad are connected in a Y-shape.

4. The antenna element according to the above 1, wherein the first radiation body and the first transmission line are formed symmetrically to the second radiation body and the second transmission line based on the signal pad.

5. The antenna element according to the above 1, wherein the first transmission line and the second transmission line have a length of 0.5 mm to 7.0 mm, respectively.

6. The antenna element according to the above 1, wherein the first radiation body and the second radiation body have a square shape, the first transmission line is connected to a center of one side of the first radiation body, and the second transmission line is connected to a center of one side of the second radiation body.

7. The antenna element according to the above 1, further including: two ground pads disposed to face each other with the signal pad interposed therebetween.

8. An antenna array including a plurality of the antenna elements according to the above 1.

9. The antenna array according to the above 8, wherein the plurality of antenna elements are arranged to be spaced apart from each other in a width direction of the antenna elements.

10. The antenna array according to the above 9, wherein a distance between adjacent antenna elements is 8 mm to 12 mm.

11. The antenna array according to the above 8, wherein the plurality of antenna elements are arranged to be overlapped with each other in a width direction of the antenna elements.

12. The antenna array according to the above 11, wherein the adjacent antenna elements share one radiation body.

13. The antenna array according to the above 12, wherein the one radiation body serves as a second radiation body of one of the adjacent antenna elements and serves as a first radiation body of the other one of the adjacent antenna elements.

14. The antenna array according to the above 11, wherein a distance between adjacent antenna elements is 4 mm to 6 mm.

15. A display device including the antenna element according to the above 1.

In the antenna element according to an exemplary embodiment, since two radiation bodies are connected to one signal pad thus to radiate a signal applied to the one signal pad through the two radiation bodies, it is possible to save a space for mounting the antenna and improve an antenna gain.

In one embodiment, the function of the antenna may be maximized by arranging the plurality of antenna elements to be spaced apart from or overlapped with each other.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic cross-sectional view illustrating an antenna element according to an embodiment;

FIG. 2 is a schematic plan view of an antenna element according to an embodiment;

FIG. 3 is a view illustrating an antenna array according to an embodiment;

FIG. 4 is a view illustrating an antenna array according to another embodiment; and

FIG. 5 is a schematic plan view illustrating a display device according to an exemplary embodiment.

### DETAILED DESCRIPTION

Hereinafter, preferred embodiments of the present invention will be described in detail with reference to the accompanying drawings. However, since the drawings attached to the present disclosure are only given for illustrating one of preferable various embodiments of present invention to easily understand the technical spirit of the present invention with the above-described invention, it should not be construed as limited to such a description illustrated in the drawings.

An antenna element described in the present disclosure may be a patch antenna or a microstrip antenna manufactured in a form of a transparent film. For example, the antenna element may be applied to electronic devices for high frequency or ultra-high frequency (e.g., 3G, 4G, 5G or more) mobile communication, Wi-Fi, Bluetooth, near field communication (NFC), global positioning system (GPS), and the like, but it is not limited thereto. Herein, the electronic device may include a mobile phone, a smart phone, a tablet, a laptop computer, a personal digital assistant (PDA), a portable multimedia player (PMP), a navigation device, an MP3 player, a digital camera, a wearable device and the like. The wearable device may include a wristwatch type, a wrist band type, a ring type, a belt type, a necklace type, an ankle band type, a thigh band type, a forearm band type wearable device or the like. However, the electronic device is not limited to the above-described example, and the wearable device is also not limited to the above-described example. In addition, the antenna element may be applied to various objects or structures such as vehicles and buildings.

In the following drawings, two directions which are parallel to an upper surface of a dielectric layer and cross each other perpendicularly are defined as an x direction and a y direction, and a direction perpendicular to the upper surface of the dielectric layer is defined as a z direction. For example, the x direction may correspond to a width direction of the antenna element, the y direction may correspond to a length direction of the antenna element, and the z direction may correspond to a thickness direction of the antenna element.

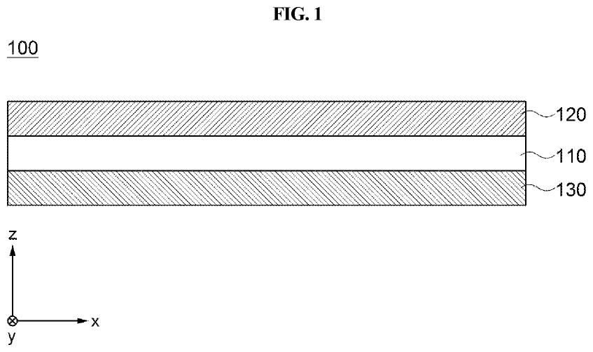

FIG. 1 is a schematic cross-sectional view illustrating an antenna element according to an embodiment.

Referring to FIG. 1, an antenna element 100 according to an embodiment may include a dielectric layer 110 and an antenna conductive layer 120.

The dielectric layer 110 may include an insulation material having a predetermined dielectric constant. According to an embodiment, the dielectric layer 110 may include an inorganic insulation material such as glass, silicon oxide, silicon nitride, or metal oxide, or an organic insulation material such as an epoxy resin, an acrylic resin, or an imide resin. The dielectric layer 110 may function as a film substrate of the antenna element 100 on which the antenna conductive layer 120 is formed.

According to an embodiment, a transparent film may be provided as the dielectric layer 110. In this case, the transparent film may include a polyester resin such as polyethylene terephthalate, polyethylene isophthalate, polyethylene naphthalate, polybutylene terephthalate, etc.; a cellulose resin such as diacetyl cellulose, triacetyl cellulose, etc.; a polycarbonate resin; an acrylic resin such as polymethyl (meth)acrylate, polyethyl (meth)acrylate, etc.; a styrene resin such as polystyrene, acrylonitrile-styrene copolymer, etc.; a polyolefin resin such as polyethylene, polypropylene, cyclic polyolefin or polyolefin having a norbornene structure, ethylene-propylene copolymer, etc.; a vinyl chloride resin; an amide resin such as nylon, aromatic polyamide; an imide resin; a polyether sulfonic resin; a sulfonic resin; a polyether ether ketone resin; a polyphenylene sulfide resin; a vinylalcohol resin; a vinylidene chloride resin; a vinylbutyral resin; an allylate resin; a polyoxymethylene resin; a thermoplastic resin such as an epoxy resin and the like. These compounds may be used alone or in combination of two or more thereof. In addition, a transparent film made of a thermosetting resin or an ultraviolet curable resin such as (meth)acrylate, urethane, acrylic urethane, epoxy, silicone, and the like may be used as the dielectric layer 110.

According to an embodiment, an adhesive film such as an optically clear adhesive (OCA), an optically clear resin (OCR), and the like may also be included in the dielectric layer 110.

According to an embodiment, the dielectric layer 110 may be formed in a substantial single layer, or may be formed in a multilayer structure of two or more layers.

Capacitance or inductance may be generated by the dielectric layer 110, thus to adjust a frequency band which can be driven or sensed by the antenna element 100. When the dielectric constant of the dielectric layer 110 exceeds about 12, a driving frequency is excessively reduced, such that driving of the antenna in a desired high frequency band may not be implemented. Therefore, according to an embodiment, the dielectric constant of the dielectric layer 110 may be adjusted in a range of about 1.5 to 12, and preferably about 2 to 12. Further, according to an embodiment, the dielectric layer 110 may have a thickness of 4 μm to 1000 μm so that the antenna element 100 can be driven in a desired high frequency band. However, the present invention is not limited thereto, and the dielectric constant and thickness of the dielectric layer 110 may be variously altered according to a desired frequency band.

According to an embodiment, an insulation layer (e.g., an encapsulation layer, a passivation layer, etc. of a display panel) inside the display device on which the antenna element 100 is mounted may be provided as the dielectric layer 110.

The antenna conductive layer 120 may be disposed on an upper surface of the dielectric layer 110.

The antenna conductive layer 120 may include a low resistance metal such as silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca), or an alloy including at least one thereof. These may be used alone or in combination of two or more thereof. For example, the antenna conductive layer 120 may include silver (Ag) or a silver alloy (e.g., a silver-palladium-copper (APC) alloy) to implement a low resistance. As another example, the antenna conductive layer 120 may include copper (Cu) or a copper alloy (e.g., a copper-calcium (CuCa) alloy) in consideration of low resistance and fine line width patterning.

According to an embodiment, the antenna conductive layer 120 may include a transparent conductive oxide such as indium tin oxide (ITO), indium zinc oxide (IZO), indium zinc tin oxide (IZTO), zinc oxide (ZnOx), or copper oxide (CuO).

According to an embodiment, the antenna conductive layer 120 may include a lamination structure of a transparent conductive oxide layer and metal layer, for example, may have a two-layer structure of transparent conductive oxide layer-metal layer or a three-layer structure of transparent conductive oxide layer-metal layer-transparent conductive oxide layer. In this case, resistance may be reduced to improve signal transmission speed while improving flexible properties by the metal layer, and corrosion resistance and transparency may be improved by the transparent conductive oxide layer.

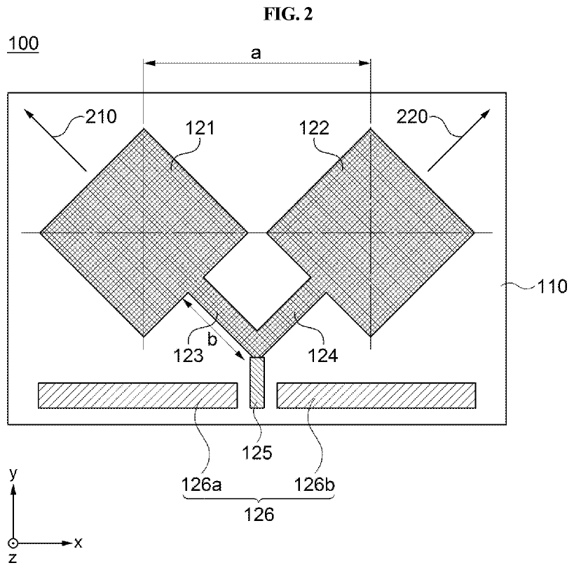

Specific details of the antenna conductive layer 120 will be described below with reference to FIG. 2.

According to an embodiment, the antenna element 100 may further include a ground layer 130. Since the antenna element 100 includes the ground layer 130, vertical radiation characteristics may be implemented.

The ground layer 130 may be disposed on a lower surface of the dielectric layer 110. The ground layer 130 may be overlapped with the antenna conductive layer 120 with the dielectric layer 110 interposed therebetween. For example, the ground layer 130 may be entirely overlapped with radiation bodies (see 121 and 122 in FIG. 2) of the antenna conductive layer 120.

According to an embodiment, a conductive member of the display device or display panel on which the antenna element 100 is mounted may be provided as the ground layer 130. For example, the conductive member may include electrodes or wirings such as a gate electrode, source/drain electrodes, pixel electrode, common electrode, data line, scan line, etc. of a thin film transistor (TFT) included in the display panel; and a stainless steel (SUS) plate, heat radiation sheet, digitizer, electromagnetic wave shielding layer, pressure sensor, fingerprint sensor, etc. of the display device.

FIG. 2 is a schematic plan view of an antenna element according to an embodiment.

Referring to FIGS. 1 and 2, the antenna element 100 according to an embodiment includes the antenna conductive layer 120 disposed on the dielectric layer 110, and the antenna conductive layer 120 may include a first radiation body 121, a second radiation body 122, a first transmission line 123, a second transmission line 124 and a signal pad 125.

The first radiation body 121 may be disposed on the upper surface of the dielectric layer 110 in a first direction 210, and the second radiation body 122 may be disposed on the upper surface of the dielectric layer 110 in a second direction 220. Herein, the first direction 210 and the second direction 220 may be perpendicular to a thickness direction (z direction) of the antenna element 100, and may intersect a length direction (y direction) of the antenna element 100. In addition, the first direction 210 and the second direction 220 may intersect each other. In this case, the first direction 210 and the second direction 220 may be perpendicular to each other, but this is only an exemplary embodiment and there is no particular limitation on an angle formed by the first direction 210 and the second direction 220.

The first radiation body 121 and the second radiation body 122 may have substantially the same resonance frequency. To this end, shapes and sizes (lengths and widths) of the first radiation body 121 and the second radiation body 122 may be substantially the same as each other. The lengths and widths of the first radiation body 121 and the second radiation body 122 may be determined according to the desired resonance frequency, radiation resistance and gain.

According to an embodiment, the first radiation body 121 and the second radiation body 122 may be formed in a mesh structure as shown in FIG. 2. Alternatively, the first radiation body 121 and the second radiation body 122 may also be formed in a solid structure (thin film or thick film). When the first radiation body 121 and the second radiation body 122 are formed in a mesh structure, transmittances of the first radiation body 121 and the second radiation body 122 may be increased, and flexibility of the antenna element 100 may be improved. Accordingly, the antenna element 100 may be effectively applied to a flexible display device.

According to an embodiment, the first radiation body 121 and the second radiation body 122 may have a square shape, respectively, as shown in FIG. 2. However, this is only an example, and there is no particular limitation on the shapes of the first radiation body 121 and the second radiation body 122. That is, the first radiation body 121 and the second radiation body 122 may have various planar shapes such as a rhombus, a circle, and a polygon, etc., or may have various planar shapes including one or more notches.

According to an embodiment, in order to reduce an interference between the first radiation body 121 and the second radiation body 122, an interval a between a center of the first radiation body 121 and a center of the second radiation body 122 may be λ/2 or more.

The first transmission line 123 may be formed on the dielectric layer 110 to electrically connect the signal pad 125 and the first radiation body 121, and the second transmission line 124 may be formed on the dielectric layer 110 to electrically connect the signal pad 125 and the second radiation body 122. More specifically, the first transmission line 123 may have one end connected to the signal pad 125, and the other end which extends from the signal pad 125 in the first direction 210 to be connected to the first radiation body 121. Similarly, the second transmission line 124 may have one end connected to the signal pad 125, and the other end which extends from the signal pad 125 in the second direction 220 to be connected to the second radiation body 122. For example, the first transmission line 123 may be connected to a center of one side of the first radiation body 121, and the second transmission line 124 may be connected to a center of one side of the second radiation body 122.

According to an embodiment, the first transmission line 123 and the second transmission line 124 may have the same length as each other. For example, in order to drive the antenna element 100 in a desired high frequency band, the first transmission line 123 and the second transmission line 124 may have a length b of 0.5 mm to 7.0 mm, respectively. However, the present invention is not limited thereto, and the length b of the first transmission line 123 and the second transmission line 124 may be variously altered according to the desired frequency band.

According to an embodiment, one ends of the first transmission line 123 and the second transmission line 124, which are connected to the signal pad 125, may be connected to each other. Therefore, as shown in FIG. 2, the first transmission line 123, the second transmission line 124 and the signal pad 125 may be connected in a Y-shape.

According to an embodiment, the first radiation body 121, the second radiation body 122, the first transmission line 123 and the second transmission line 124 may have a symmetrical structure. For example, the first radiation body 121 and the second radiation body 122 may be formed symmetrically, and the first transmission line 123 and the second transmission line 124 may be formed symmetrically based on the signal pad 125.

According to an embodiment, the first transmission line 123 and/or the second transmission line 124 may include substantially the same conductive material as the first radiation body 121 and/or the second radiation body 122. In addition, the first transmission line 123, the second transmission line 124, the first radiation body 121 and the second radiation body 122 may be integrally connected to form a substantially single member or may be formed as separate members.

According to an embodiment, the first transmission line 123 and the second transmission line 124 may be formed in a mesh structure as are shown in FIG. 2. Alternatively, the first transmission line 123 and the second transmission line 124 may be formed in a solid structure (thin film or thick film).

Meanwhile, when the first radiation body 121, the second radiation body 122, the first transmission line 123 and the second transmission line 124 are formed in a mesh structure, the first radiation body 121, the second radiation body 122, the first transmission line 123 and the second transmission line 124 may be formed in a mesh structure having substantially the same shape (e.g., the same line width and the same interval), but it is not limited thereto.

The signal pad 125 is connected to the one ends of the first transmission line 123 and the second transmission line 124 to transmit a signal to the first radiation body 121 and the second radiation body 122 through the first transmission line 123 and the second transmission line 124, respectively. That is, the signal pad 125 may transmit the same signal to the first radiation body 121 and the second radiation body 122 through the first transmission line 123 and the second transmission line 124.

The antenna element 100 according to an embodiment may apply the same signal to two radiation bodies 121 and 122 through one signal pad 125 to radiate it through the two radiation bodies 121 and 122, such that it is possible to improve the antenna gain, compared to the case of applying a signal to one radiation body.

The signal pad 125 may be electrically connected to a driving circuit unit (e.g., a radio frequency integrated circuit (RFIC), etc.). For example, a flexible printed circuit board (FPCB) may be bonded to the signal pad 125, and a circuit wiring of the FPCB may be electrically connected to the signal pad 125. For example, the signal pad 125 may be electrically connected to the FPCB using an anisotropic conductive film (ACF) bonding technique, which is a bonding method that allows electrical conduction up and down and insulates left and right using an anisotropic conductive film (ACF), or using a coaxial cable, but it is not limited thereto. The driving circuit unit may be mounted on the FPCB or a separate printed circuit board (PCB) to be electrically connected to the transmission line of the FPCB. Accordingly, the signal pad 125 and the driving circuit unit may be electrically connected with each other.

According to an embodiment, the antenna conductive layer 120 may further include a ground pad 126.

The ground pad 126 may be disposed around the signal pad 125 so as to be electrically and physically separated from the signal pad 125. For example, the ground pad 126 may include a first ground pad 126a and a second ground pad 126b, and the first ground pad 126a and the second ground pad 126b may be disposed to face each other with the signal pad 125 interposed therebetween.

According to an embodiment, the signal pad 125 and the ground pad 126 may be formed in a solid structure including the above-described metal or alloy to reduce a signal resistance. According to an embodiment, the signal pad 125 and the ground pad 126 may be formed in a multilayer structure including the above-described metal or alloy layer and the transparent conductive oxide layer.

Meanwhile, according to an embodiment, when the first radiation body 121, the second radiation body 122, the first transmission line 123 and the second transmission line 124 are formed in a mesh structure, a dummy pattern (not illustrated) may be formed around the first radiation body 121, the second radiation body 122, the first transmission line 123 and the second transmission line 124. The dummy pattern may be electrically and physically separated from the first radiation body 121, the second radiation body 122, the first transmission line 123 and the second transmission line 124. In addition, the dummy pattern may include substantially the same conductive material as the first radiation body 121, the second radiation body 122, the first transmission line 123 and/or the second transmission line 124, and may be formed in a mesh structure having substantially the same shape (e.g., the same line width and the same interval) as the first radiation body 121, the second radiation body 122, the first transmission line 123 and/or the second transmission line 124. According to an embodiment, the dummy pattern may be formed in a segmented mesh structure.

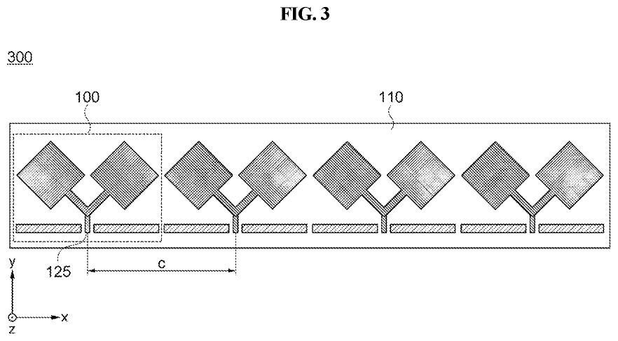

FIG. 3 is a view illustrating an antenna array according to an embodiment. In description of FIG. 3, substantially the same structure and configuration thereof as those described with reference to FIGS. 1 and 2 may not be described.

Referring to FIG. 3, an antenna array 300 according to an embodiment may include a plurality of antenna elements 100 arranged to be spaced apart from each other in a width direction (x-direction) of the antenna element 100.

According to an embodiment, a distance c between adjacent antenna elements 100 may be 8 mm to 12 mm. In this case, the distance c between the adjacent antenna elements 100 may mean a distance between signal pads 125 included in each of the adjacent antenna elements 100 as shown in FIG. 3.

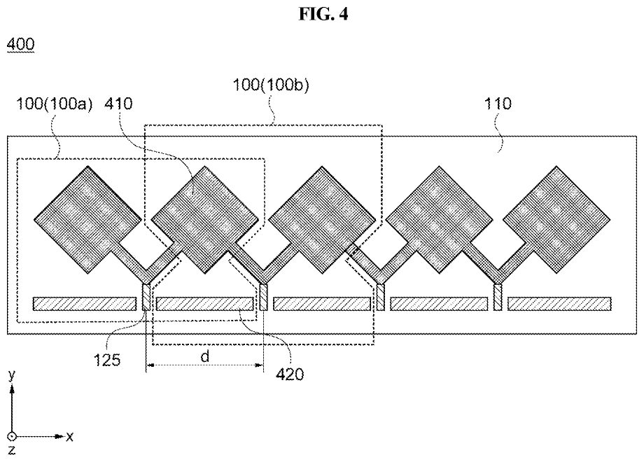

FIG. 4 is a view illustrating an antenna array according to another embodiment. In description of FIG. 4, substantially the same structure and configuration thereof as those described with reference to FIGS. 1 to 3 may not be described.

Referring to FIG. 4, an antenna array 400 according to another embodiment may include a plurality of antenna elements 100 arranged to be overlapped with at least a portion in the width direction (x-direction) of the antenna element 100.

Adjacent antenna elements 100a and 100b may share one radiation body 410 and one ground pad 420. For example, the radiation body 410 may be a second radiation body 122 of the antenna element 100a and a first radiation body 121 of the antenna element 100b. That is, the radiation body 410 may serve as the second radiation body 122 of the antenna element 100a and as the first radiation body 121 of the antenna element 100b. In addition, the ground pad 420 may be a second ground pad 126b of the antenna element 100a and a first ground pad 126a of the antenna element 100b. That is, the ground pad 420 may serve as the second ground pad 126b of the antenna element 100a and as the first ground pad 126a of the antenna element 100b.

According to an embodiment, a distance d between the adjacent antenna elements 100a and 100b may be 4 mm to 6 mm. In this case, the distance d between the adjacent antenna elements 100a and 100b may mean a distance between signal pads 125 included in each of the adjacent antenna elements 100a and 100b.

According to an embodiment, the same signal of the same phase may be substantially simultaneously applied to all signal pads 125 in the antenna arrays 300 and 400. Accordingly, all radiation bodies in the antenna arrays 300 and 400 radiate the same signal, such that an entire antenna gain may be improved.

Meanwhile, FIGS. 3 and 4 shows an example in which four antenna elements are arranged to be spaced apart from or at least partially overlapped with each other, but this is only for the convenience of illustration and description, and there is no particular limitation on the number of the arranged antenna elements.

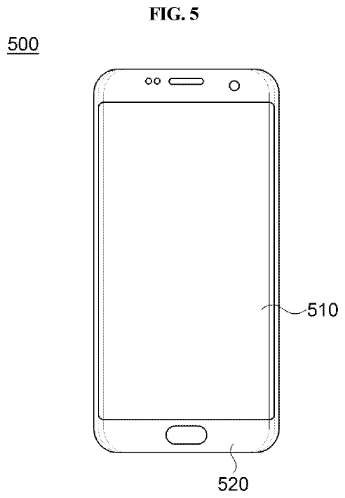

FIG. 5 is a schematic plan view illustrating a display device according to an exemplary embodiment. More specifically, FIG. 5 is a view illustrating an external shape including a window of the display device.

Referring to FIG. 5, a display device 500 may include a display region 510 and a peripheral region 520.

The display region 510 may indicate a region in which visual information is displayed, and the peripheral region 520 may indicate an opaque region disposed on both sides and/or both ends of the display region 510. For example, the peripheral region 520 may correspond to a light-shielding part or a bezel part of the display device 500.

According to an embodiment, the above-described antenna element 100 or antenna arrays 300 and 400 may be mounted on the display device 500 in a form of a film or patch. For example, the radiation bodies 121 and 122 and the transmission lines 123 and 124 of the antenna element 100 or the antenna arrays 300 and 400 may be disposed to at least partially correspond to the display region 510, and the signal pad 125 and the ground pad 126 may be disposed to correspond to the peripheral region 520.

In the peripheral region 520, the FPCB or PCB may be disposed together with the driving circuit unit. By disposing the antenna element 100 and the signal pads 125 of the antenna arrays 300 and 400 so as to be adjacent to the driving circuit unit, signal loss may be suppressed by shortening a path for transmitting and receiving signals.

Since the antenna element 100 or the radiation bodies 121 and 122 and/or transmission lines 123 and 124 of the antenna arrays 300 and 400 include the dummy pattern formed in a mesh structure, it is possible to improve transmittance and reduce or suppress the pattern from being viewed by a user. Accordingly, the image quality in the display region 510 may also be improved, while maintaining or improving desired communication reliability.

The present invention has been described with reference to the preferred embodiments above, and it will be understood by those skilled in the art that various modifications may be made within the scope without departing from essential characteristics of the present invention. Accordingly, it should be interpreted that the scope of the present invention is not limited to the above-described embodiments, and other various embodiments within the scope equivalent to those described in the claims are included within the present invention.

What is claimed is:

1. An antenna element comprising:
a first radiation body disposed in a first direction;
a second radiation body disposed in a second direction;
a signal pad configured to supply a signal to the first radiation body and the second radiation body;
a first transmission line which extends from the signal pad in the first direction to be connected to the first radiation body; and
a second transmission line which extends from the signal pad in the second direction to be connected to the second radiation body.

2. The antenna element according to claim 1, wherein the first transmission line and the second transmission line having one end connected to the signal pad, respectively.

3. The antenna element according to claim 2, wherein the first transmission line, the second transmission line and the signal pad are connected in a Y-shape.

4. The antenna element according to claim 1, wherein the first radiation body and the first transmission line are formed symmetrically to the second radiation body and the second transmission line based on the signal pad.

5. The antenna element according to claim 1, wherein the first transmission line and the second transmission line have a length of 0.5 mm to 7.0 mm, respectively.

6. The antenna element according to claim 1, wherein the first radiation body and the second radiation body have a square shape;
the first transmission line is connected to a center of one side of the first radiation body; and
the second transmission line is connected to a center of one side of the second radiation body.

7. The antenna element according to claim 1, further comprising: two ground pads disposed to face each other with the signal pad interposed therebetween.

8. An antenna array comprising a plurality of the antenna elements according to claim 1.

9. The antenna array according to claim 8, wherein the plurality of antenna elements are arranged to be spaced apart from each other in a width direction of the antenna elements.

10. The antenna array according to claim 9, wherein a distance between adjacent antenna elements is 8 mm to 12 mm.

11. The antenna array according to claim 8, wherein the plurality of antenna elements are arranged to be overlapped with each other in a width direction of the antenna elements.

12. The antenna array according to claim 11, wherein the adjacent antenna elements share one radiation body.

13. The antenna array according to claim 12, wherein the one radiation body serves as a second radiation body of one of the adjacent antenna elements and serves as a first radiation body of the other one of the adjacent antenna elements.

14. The antenna array according to claim 11, wherein a distance between adjacent antenna elements is 4 mm to 6 mm.

15. A display device comprising the antenna element according to claim 1.
